(19) United States
(12) Patent Application Publication
(10) Pub. No.: US 2024/0139814 A1
(43) Pub. Date: May 2, 2024

(54) Removing the Support Structure by Means of a Laser Beam Integrated on a Robot Arm

(71) Applicant: KSB SE & Co. KGaA, Frankenthal (DE)

(72) Inventor: Tammuz NOBEL, Frankenthal (DE)

(21) Appl. No.: 18/280,042

(22) PCT Filed: Mar. 2, 2022
(86) PCT No.: PCT/EP2022/055231

§ 371 Date: Sep. 1, 2023

(30) Foreign Application Priority Data
Mar. 4, 2021 (DE) 10 2021 105 228.9

(51) Int. Cl. B22F 10/40; B22F 10/64; B33Y 10/00; B33Y 40/20; B33Y 80/00

(52) U.S. Cl. CPC B22F 10/40; B22F 10/64; B33Y 10/00; B33Y 40/20; B33Y 80/00

(57) ABSTRACT

A generatively manufactured object includes at least one functional region. The at least one functional region has a supporting function. The at least one functional region is removed using a tool after manufacture. The at least one functional region with a supporting function is removed using a radiation source.

The invention relates to a generatively manufactured object having at least one functional region with a supporting function, which is removed using a tool after manufacture.

Such a generatively manufactured object may for example be a part of a centrifugal pump, for instance an impeller or a pump casing, or a part of a faucet, for example a check body or a valve casing.

In the generative manufacturing of objects, the object in question is constructed layer by layer from a construction material, which is applied onto a base. The construction material is usually in the form of powder. The powder material is locally melted fully by means of radiation at the respective locations and, after solidification, forms a solid material layer. The base plate on which the powder material is located is then lowered by the amount of one layer thickness and powder is again applied. This cycle is repeated until all the layers have been produced. Excess powder is cleaned from the finished object.

The data for guiding the radiation are generated by means of software on the basis of a 3D CAD body. For example, a laser beam may be used as the radiation. As an alternative to selective laser melting, an electron beam may also be used (EBM).

For each layer, the regions that form the structures of the object are selectively melted. In order to connect the underlying layer to the overlying layer in the next step, the radiation melts up to 3 underlying layers which subsequently fuse with the uppermost layer during the rapid cooling process.

The consequence of this process is that new layers can generally be placed only on already existing layers. Otherwise, the laser might melt regions that do not belong to the object. On the lower side of an overhang, for example, very rough faces may be formed. In the case of particularly relatively steep overhangs, substantial deformities may occur in the component since the overlying layer has to be constructed on a layer that is too irregular.

It is therefore important for such overhangs to be supported by a support structure. Furthermore, the support structure also contributes to controlled thermal dissipation and therefore to the process reliability. Since the construction material in the form of powder has an insulating effect, strong heating in the component could otherwise lead to overheating. Furthermore, the support structure prevents the component from being distorted by process-induced stresses which occur because of the rapid heating and subsequent cooling.

Since the support structure does not belong to the actual object, it needs to be removed after the manufacturing process. This proves to be extremely difficult and time-consuming particularly in the case of support structures that are difficult to reach. Sometimes, the support structure can no longer be entirely removed because of substantial bonding to the object, so that the surfaces on which the support structure was fastened have a poor quality.

Strategically expedient placement of the support structure, suitable orientation in the construction space, in order to make do with the fewest possible support structures, as well as the subsequent removal of the support represent one of the greatest time factors and therefore a major cost aspect of generative methods.

DE 102 19 983 B4 describes a method for producing metallic or nonmetallic products by freeform laser sintering. In this case, the products are constructed layerwise in the vertical direction from a powder material on a substrate plate by means of a laser beam guided with data control. At least one support, which is connected to the outer face of the product by means of a predetermined breaking point, is constructed between the substrate plate and the outer face of the product. The predetermined breaking point is formed by a reduction of the strength of the support along the outer contour of the product. In this case, the cross section of the support is narrowed in order to reduce the strength.

A method for producing three-dimensional components is described in DE 10 2007 033 434 A1. In this case, an auxiliary structure is additionally formed beyond an extent of the component during construction of components. Predetermined breaking points are provided at connecting points between the component and the auxiliary structure.

DE 10 2013 011 630 A1 describes a method for calculating one or more support struts for a three-dimensional object on a platform, the object being constructed from layers by a manufacturing method. The support elements in this case not only form stable connecting points but also have predetermined breaking points. The support structure is intended to be separable easily from the object without craters being created on the object surface.

Support structures that are required for the construction of an object need to be removed by hand and mechanically after manufacture by the generative method. This leads to significant personnel and financial outlay, which may prevent the implementation of generative manufacturing in industrial manufacturing. Here, a generative manufacturing method with manual finishing is in competition with highly developed and economically optimized, conventional manufacturing processes.

DE 10 2015 218 753 A1 describes a method for the additive production of a component, in which different powders are fused to form layers with the aid of an energy beam. For machine-based manufacturing, the method is supplemented with a suction device in order to remove excess powder. This approach can lead to a reduction of manual finishing operations.

DE 10 2019 002 292 A1 describes another approach. In order to entirely obviate support structures and their removal by hand, the construction layers are printed on a base segment plate. This works in the case of impellers for centrifugal pumps since overhangs do not need to be applied here. In this example, the construction takes place only on the face of the base segment plate.

Irrespective of the manual outlay for removing the support structures, the remaining surfaces of the generatively created objects are both not always visually appealing and not optimally configured for the subsequent use. Here, a further processing step is often carried out in order to condition the surfaces of the generatively manufactured object, which in turn has an economically detrimental effect on the competitivity of generative manufacturing.

DE 10 2015 202 417 A1 describes a more promising approach. A flow-guiding component with different functional regions is generatively manufactured. By varying the radiation and the energy input, different functional regions are created from a metallic material in powder form.

It is an object of the invention to provide a generatively manufactured object which can be manufactured without manual finishing by hand. In this case, the surfaces of the generatively manufactured object are intended to be rendered visually appealing and particularly wear-resistant. The intention is that finishing of the surfaces of the generatively manufactured object can be obviated. The generatively manufactured object is intended to be distinguished by a long service life and reliable usability. Furthermore, the component is intended to be highly compatible with recycling.

This object is achieved according to the invention by a generatively manufactured object and by a method for creating the latter. Preferred variants may be found in the dependent claims, the description and the drawings.

According to the invention, the functional region with a supporting function of a generatively manufactured object is removed using a radiation source.

As the radiation source, or radiation, for example a laser beam or an electron beam and the associated equipment for generating the radiation may be used. The data for guiding the radiation are generated on the basis of a 3D CAD body of the generatively manufactured object with the aid of the method software. The functional region with a supporting function and the surfaces of the generatively manufactured object are therefore known exactly. Advantageously, with precisely these data and the same radiation source or radiation, the support structures that are no longer required may be removed and the morphology of the surface may be altered, so that it is modified in a visually appealing way and ideally for the subsequent use. Manual finishing may be entirely obviated in the case of the object according to the invention and by the method according to the invention.

During selective laser melting, the generatively manufactured object is produced by a method in which a layer of a construction material is initially applied onto a base. Preferably, the construction material for producing the generatively manufactured object consists of metal powder particles. In one variant of the invention, powder particles containing iron and/or cobalt are used for this purpose. They may contain additives such as chromium, molybdenum or nickel. The metal construction material is applied in powder form onto a plate in a thin layer. The powder material is then locally melted fully by means of radiation at the respectively desired locations and, after solidification, forms a solid material layer. The base is then lowered by the amount of one layer thickness and powder is again applied. This cycle is repeated until all the layers have been produced and the finished object has been obtained. According to the invention, different functional regions of the object are in this case formed, in particular including the functional region with a supporting function.

An electron beam is a technically generated ray bundle of electrons. Electron beams interact strongly with matter. For example, a solid body, in particular a metallic solid body, becomes heated when it is irradiated with electron beams. This is used inter alia to melt a metallic construction material, for example during electron beam melting. By means of corresponding beam guiding, structures in the micrometer to nanometer range may readily be influenced. In metal processing, electron beams with a high power are used for melting, hardening, annealing, etching and welding. Processing with an electron beam is preferably carried out in a vacuum.

According to the invention, the surface of the generatively manufactured component is altered in its morphology. Morphology is a term from metallurgy and crystallography, which describes the form of a metal lattice or crystal which consists of geometrically determined faces, edges and vertices.

Advantageously, the surface of the generatively manufactured object, which is unevenly and roughly configured after the removal of the functional region with a supporting function, is optimized with the aid of the radiation source. In particular, the smoothness and roughness of the object surface are adapted on the one hand to the visual requirements and on the other hand to the requirements for use.

Ideally, the hardness of the surface may for example be increased in the case of use as a functional region in contact with abrasive media, in order to generate a wear-resistant contact face.

According to the invention, the functional region with a supporting function, in particular the support structures, is ablated layerwise. The data for guiding the radiation are provided in the form of a 3D CAD body, which is generated layerwise by melting powder granules. Precisely these data are the basis for the removal of the support structures, which is likewise carried out layerwise. Layerwise removal is particularly suitable because it is extremely precise and functions exactly in a way which is defined with layers. In comparison with manual removal of the support structure, it is therefore possible to work much more accurately and smoothly, which leads to a high-quality product.

In one particularly advantageous variant of the invention, the morphology of the generatively manufactured object is altered directly during the removal of the functional region with a supporting function. Generative manufacturing of an object with the full and direct completion of the object is in this case highly satisfactory, so that finishing by hand or another processing step with corresponding machine preparation may be entirely obviated.

According to the invention, a generatively manufactured object is formed in an integrative manufacturing method. The 3D shape of the object is stored as a data set in software. At the locations where the object is intended to be formed, a robot arm which has tools of various generative construction processes acts and forms the functional regions of the object layer by layer, in particular the functional region with a supporting function. Advantageously, the suitable construction process for each construction material may be carried out successively or simultaneously for each layer, so that it is also possible to obtain a complex object consisting of different materials, the regions of which are adapted optimally to the requirements of the subsequent use.

In one variant of the invention, it is conceivable for functional regions of the object to be generated layerwise, even in the form of a lattice structure, with a molten layer tool of the generative manufacturing method in which a grid of points of meltable plastic is applied onto a face. By extrusion using a nozzle and subsequent hardening by cooling at the desired position, a load-bearing structure is generated, particularly in the form of a lattice and/or in the form of honeycombs. By the supporting region of an object being generated for example so as to form cavities with a particularly load-bearing structure, an object has an enormous strength together with a very low mass. The construction of an object is conventionally carried out by repeatedly scanning a working plane in rows and then displacing the working plane upward in a stacking fashion so that the object with its functional regions, in particular the functional region with a supporting function, is obtained.

In one particularly advantageous variant of the invention, the generatively manufactured object is produced from a construction material by successive melting of layers by means of radiation and solidification. The different properties of the functional regions of a generatively manufactured object are in this case generated by varying the radiation, the radiation energy and the radiation intensity. By purposeful control of the local heat introduction, inter alia by means of the scan rate of the radiation, a modification of the material properties is already carried out during the construction of the generatively manufactured object. In a region of the object, particularly in the morphology of the surface, it is therefore possible to generate zones and microstructures with different material states of a chemically homogeneous material, and therefore different properties.

The metal construction material is applied in powder form onto a plate in a thin layer. The powder material is then locally melted fully by means of radiation at the respectively desired locations and, after solidification, forms a solid material layer. This base plate is then lowered by the amount of one layer thickness and powder is again applied. This cycle is repeated until all the layers have been produced. The excess powder is sucked off from the finished object with the aid of the integrative manufacturing tool.

The functional region with a supporting function, which in particular is indispensable for objects manufactured with an overhang, is subsequently ablated layerwise by the action of radiation. According to the invention, the radiation source of the laser of the integrative manufacturing tool is guided by the data set of the 3D CAD body so that the functional regions with a supporting function of the generatively manufactured object are ablated extremely precisely.

Advantageously, the morphology of the surface of the generatively manufactured object is optimized simultaneously and directly during the removal of the functional region with a supporting function by varying the radiation energy, the radiation intensity and the scan rate of the radiation. Ideally, the manufacturing of the generatively manufactured object may be performed entirely in an integrative manufacturing unit. In this way, the costs for the generative manufacturing of an object are reduced significantly, the use of workers for finishing is completely reduced and the surface quality of the finished object is improved enormously.

Further features and advantages of the invention may be found in the description of an exemplary embodiment with the aid of the drawing and in the drawing itself, in which:

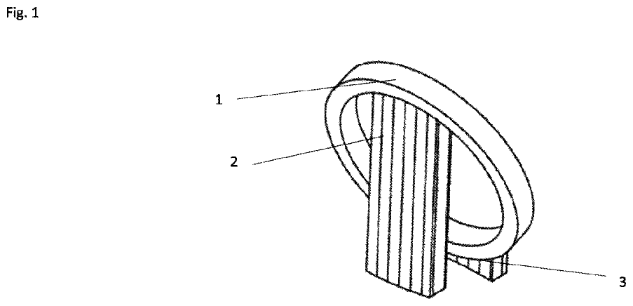

FIG. 1 shows a generatively manufactured object having a functional region with a supporting function,

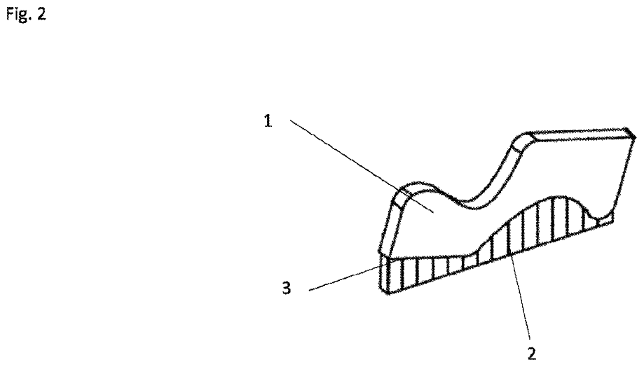

FIG. 2 shows a further generatively manufactured object having a functional region with a supporting function.

FIG. 1 represents a generatively manufactured object 1 which has at least one functional region with a supporting function 2. In this exemplary embodiment, the generatively manufactured object 1 is configured as a split ring and the functional region with a supporting function 2 is configured as a support structure. The support structure is necessary in order to form and likewise hold the generatively manufactured object 1 in its shape during the layerwise construction. The support structure is ablated layerwise by the radiation after the formation of the generatively manufactured object 1. The surface 3 of the object 1, in particular the surface 3 on which the support structure was previously formed, is optimized in its morphology by the radiation directly during the removal of the support structure. Finishing by hand, manual removal of the support structure and an improvement of the generatively manufactured object 1 can be obviated.

FIG. 2 represents a further generatively manufactured object 1 having a functional region with a supporting function 2. In this exemplary embodiment, the generatively manufactured object 1 is formed as a honeycombed component and the functional region with a supporting function 2 is formed as a support structure. The support structure is ablated layerwise by the radiation after the formation of the generatively manufactured object 1, while the surface 3 of the generatively manufactured object is optimized in its morphology for the use of the object 1 directly during the removal of the support structure.

1-7. (canceled)

8. A generatively manufactured object comprising:
at least one functional region with a supporting function, which is removed using a tool after manufacture, wherein
the at least one functional region with a supporting function is removed using a radiation source.

9. The generatively manufactured object as claimed in claim 8, wherein the functional region with a supporting function is ablated layerwise.

10. The generatively manufactured object as claimed in claim 9, wherein a morphology of a surface of the generatively manufactured component is altered directly during the removal of the functional region with a supporting function.

11. A method for manufacturing a generative object, comprising:
selectively radiating a construction material;
forming functional regions of the object; and
selectively radiating the functional regions.

12. The method as claimed in claim 11, wherein the functional region with a supporting function is ablated layerwise by the action of radiation.

13. The method as claimed in claim 12, wherein the radiation is a data-guided laser beam.

14. The method as claimed in claim 13, wherein an energy, an intensity, and a scan rate of the radiation are varied in order to alter a morphology of the surface of the generatively manufactured object.

15. A method of making a generatively manufactured object comprising:
forming at least one functional region with a supporting function; and
removing the at least one functional region using a tool after manufacture, wherein the tool has a radiation source.

16. The method as claimed in claim 15, wherein the removing step is carried out by ablation in a layerwise fashion.

17. The method as claimed in claim 16, further comprising:
directly altering a morphology of a surface of the generatively manufactured component during the removal of the functional region with a supporting function.
